(19) United States
(12) Patent Application Publication
(10) Pub. No.: US 2025/0120420 A1
(43) Pub. Date: Apr. 17, 2025

(54) FEED ADDITIVE FOR IMPROVING ANIMAL PERFORMANCE, DIGESTION AND INTESTINAL HEALTH AND RELATED METHODS

(71) Applicant: KEMIN INDUSTRIES, INC., DES MOINES, IA (US)

(72) Inventors: Veerle Van Hoeck, Nijlen (BE); Liesbet Thys, Kasterlee (BE); Rietje Spaepen, Westerlo (BE); Filip Nuyens, Geel (BE)

(73) Assignee: KEMIN INDUSTRIES, INC., DES MOINES, IA (US)

(21) Appl. No.: 18/917,924

(22) Filed: Oct. 16, 2024

Related U.S. Application Data
(60) Provisional application No. 63/544,329, filed on Oct. 16, 2023.

(51) Int. Cl. A23K 20/189; A23K 20/163; A23K 50/70

(52) U.S. Cl. CPC A23K 20/189; A23K 20/163; A23K 50/70

(57) ABSTRACT

The present invention relates to a feed additive comprising beta 1-4, endo-xylanase enzyme and chito-oligosaccarides present in an amount that provides a synergistic improvement to monogastric animal intestinal health or nutrient digestibility. Another aspect of the present invention relates to adding a composition containing beta 1-4, endo-xylanase enzyme and chito-oligosaccarides into an animal diet or water source in order to improve animal performance.

### CROSS-REFERENCE TO RELATED APPLICATIONS

The present application claims the benefit of priority to U.S. Provisional Patent Application No. 63/544,329, filed Oct. 16, 2023, entitled “ANIMAL FEED ADDITIVE FOR PROMOTING DIGESTION AND INTESTINAL HEALTH IN ANIMALS AND RELATED METHODS,” hereinafter incorporated by reference in its entirety.

### BACKGROUND OF THE INVENTION

Animal intestinal health has attracted significant interest among veterinarians, nutritionists and researchers, with renewed focus over the past few years. This interest arises from the desire to improve gastrointestinal health aimed at animal production, such as growth, survival, and yields of milk, meat and egg quality, in order to meet global demand. Researchers have concluded that animal performance, feed efficiency, and overall health are heavily dependent on the gut health of the animal. It is also understood that changes in animal production systems and feed regulations, including moving away from the use of antibiotic growth promoters, will require the identification of new strategies to optimize gut health in novel and efficient ways.

The gastrointestinal tract has long been known as a harbor of gut microbiota. The healthy relationship between gut microbiota and the animal is important. Modification of the gut ecosystem significantly affects the intestinal health of animals. Accordingly, there remains a crucial need in the animal health industry to identify and characterize novel potential nutraceuticals that are capable of providing improved intestinal health, and thereby boosting animal growth and performance.

Further, feed additives capable of promoting the microbiome and feed digestion are becoming increasingly important in the agri-food industry, particularly as costs continue to rise. Due to recent increases in grain prices, and general long-term price volatility, the animal feed industry has been working towards lowering nutritional costs including reconsidering diet ingredients. For instance, wheat has become an important source of energy in poultry diets, even in markets that do not traditionally rely on wheat, due to shortages in corn supply and its increased costs. However, poultry do not produce endogenous carbohydrases that can breakdown or hydrolyze the non-starch polysaccharides (NSPs), such as arabinoxylans, present in viscous cereals in this diet. It has even been determined that NSP can decrease the bird's ability to efficiently utilize protein and energy from these feed materials. For this reason, the use of exogenous enzymes and other feed additives to improve poultry performance is crucial for poultry diets, with enzyme supplementation becoming a common practice in commercial poultry nutrition.

By way of background, Applicant has previously shown that the addition of xylanase enzyme into a poultry diet not only helps to reduce feed costs and animal performance, it positively influences the cecal microbiome of poultry, which is imperatively connected to poultry intestinal health. See Van Hoeck, et al., Xylanase Impact Beyond Performance: A Microbiome Approach in Laying Hens, PLoS ONE 16(9): e0257681 (2021), wherein this reference is expressly incorporated in its entirety herein.

As overall feed costs and environmental impact have become areas of concern within the feed industry, there is a renewed urgency to identify feed additives that can ensure that the feed is adequately digested and absorbed in the intestinal tract of the animals in the most efficient manner. Thus, feed additives capable of promoting digestion and animal intestinal health have become increasingly important to ensure the profitability and long-term sustainability of the animal feed industry.

### BRIEF SUMMARY OF THE INVENTION

The present invention relates to a feed additive comprising beta 1-4, endo-xylanase enzyme (hereinafter “xylanase”) and chito-oligosaccarides (hereinafter “COS”) present in an amount that provides a synergistic improvement to animal gut health. Another aspect of the present invention relates to adding a composition containing beta 1-4, endo-xylanase enzyme and COS into an animal diet or water source in order to improve animal performance.

### BRIEF DESCRIPTION OF THE FIGURES

FIG. 1-5 depict the effect of the treatment on laying hen performance.

FIG. 6-11 depict the effect of the treatment on nutrient digestibility in laying hens.

### DETAILED SUMMARY OF THE INVENTION

The present invention relates to an animal feed ingredient, or a feed additive, that contains beta 1-4, endo-xylanase enzyme and COS in an amount that provides a synergistic improvement to animal gut health. Another aspect of the present invention an animal feed ingredient, or a feed additive, that contains beta 1-4, endo-xylanase enzyme and COS in an amount that provides a synergistic improvement to animal performance.

In at least one embodiment, animal intestinal health can be measured by the histology of intestinal samples, including villus height and crypt dept. In another embodiment, the efficacy of the present invention can be shown by measuring blood cytokines, which can be proinflammatory or anti-inflammatory markers depending on the interactions in the gut epithelium.

In at least one embodiment, adding the compositions of the present invention resulted in positive changes to the cecal microbiome in poultry, which can be measured by traditional agar plating methods or more commonly by modern microbiome 16S ribosomal DNA sequencing technologies such as those based on Illumina (Novogene) or Nanopore (Pathosense).

In at least one embodiment, animal performance is measured by yields of milk, meat, egg quality and/or egg production. For instance, in at least one embodiment, poultry performance can be measured by feed conversion ratio (FCR), egg quality, egg production, or egg characteristics including egg weight, yolk color, haugh unit, proportion of dirty or cracked eggs.

In at least one embodiment, the composition of the present invention includes xylanase and COS in an amount sufficient to provide a positive effect on the microbiome, including through measurements described herein.

In another embodiment, the feed additive of the present invention improves nutrient digestion and absorption, leading to increased weight gain, for instance an improvement of at least about 1 gram weight increase per egg or about 1.6% average weight gain per egg.

In another embodiment, the feed additive of the present invention can trigger macrophage cells to express anti-inflammatory and immunostimulatory pathways.

In certain embodiments, the composition may optionally include any commonly used compounds used in animal nutrition including beta-glucanase, cellulase, protease, alpha-amylase, probiotics, prebiotics, organic acids or their salts, antioxidants, vitamins, minerals, lipids, lecithins and lysolecithins, clays, carrier materials, sugars, polyols, flavors or aromas.

In at least one embodiment of the present invention, the COS is an oligomer of N-acetylglucosamine (NACOS) with an average degree of polymerization between 2 and 6 and a degree of acetylation above 90%, having an average molecular weight of less than 2 kDa.

In at least one embodiment of the present invention, the COS has an average molecular weight ranging from about 0.2 kDa to 4 kDA. For instance, in at least one embodiment the COS has an average molecular weight under 3.9 kDA and contains less than 20 monomer units per polymer chain.

In certain embodiments, the composition containing xylanase and COS is fed to monogastric animals at a dosage ranging from about 10 g/ton feed to about 100 g/ton feed, for instance ranging from about 20 g/ton feed to about 90 g/ton, such as about 30 g/ton to about 80 g/ton. In at least one embodiment, the composition is present in an amount of at least 10 g/ton feed. In at least one embodiment, the composition is present in an amount of at least 20 g/ton feed. In yet another embodiment, the composition is present in an amount of at least 30 g/ton feed. In another embodiment, the composition is present in an amount of at least 40 g/ton feed.

In certain embodiments, the ratio of xylanase to COS falls within the range of 1:5 to 1:1, for instance the ingredients are present in a ratio of about 1:5, about 2:5, about 3:5, or 4:5.

In certain embodiments, the composition contains xylanase in an amount ranging from about 15% to about 50% by weight and COS in an amount ranging from about 50% to about 85% by weight.

According to at least one embodiment, the composition is soluble in water.

According to at least one embodiment, the compositions of the present invention are administered by adding the composition to the animal feed or drinking water.

In certain embodiments, animal refers to monogastric animals, including but not limited to poultry, swine, horses, rabbits, dogs, and cats and aqua, or pre-ruminants animals, such as veal calves.

According to at least one embodiment, the compositions of the present invention are suitable for animal feed and can be combined with known animal feed ingredients, including but not limited to corn meal, soybean meal, fish meal, sunflower meal, wheat, barley, sorghum, sunflower meal, rapeseed cake, soy oil cake, dried distillers' grains with solubles (DDGS), etc.

For purposes of this disclosure, “animal feed” refers to the animal diet and “water” refers to livestock drinking water or water supply. “Animal feed” may be provided to the animals through any convention means well known to persons skilled in the art, include but not limited to top-dress, mixed in by hand, pelleted, mixed with crumbles, etc.

### EXAMPLES

### Example 1

Materials and Methods: Chito-oligosaccharides (COS) were used for screening potential biological actions in the gastric intestinal tract. Intestinal CaCo2 cells were used as intestinal cell model in this study. The cells were exposed for 24 hours. In total, 8 replicates were produced per treatment. Cells where retrieved, snap frozen, RNA-extracted and RNA-sequenced using the NovaSeq PE150 platform (Illumina, San Diego, United States).

Results: The gene expression data revealed that there is a clear effect of the COS on the CaCo2 cell transcriptome. When comparing the 2 mg/ml treatment to the control, 3,161 genes were differently expressed, in which 1,683 were up-regulated and 1,478 were down-regulated. When comparing the 4 mg/ml treatment with the control, 5,815 genes were differently expressed of which 2,971 were up-regulated and 2,844 were down-regulated compared to the control treatment. Hence, the effect was dose dependent in which the highest dosage resulted in more differently expressed genes than the lowest dosage. Furthermore, very consistently, pathways enriched in all COS treated groups compared to control groups were related to ribosomal biosynthesis and activity. This might indicate that the latter treated cells have a higher capacity for protein biogenesis compared to the non-treated cells. Gene transcription was enriched for genes related to anti-oxidative capacity. To summarize, COS have a positive impact on the intestinal tract of the animal.

### Example 2

Materials and Methods: A polarized cell culture system was set up to mimic the intestinal tract, in which apically the CaCo2 cells were seeded and, in the basolateral compartment, RAW 264.7 macrophage cells were grown.

Results: The gene expression data revealed that there is a clear effect of the COS on the macrophage cell transcriptome. The effect was dose dependent in which the highest dosage resulted in more differently expressed genes than the lowest dosage. For the macrophage cells, 3,345 genes were differently expressed when comparing the 2 mg/ml versus control and 4,246 genes were differently expressed when comparing the 4 mg/ml versus the control. Here, pathways enriched in all COS treated groups compared to control groups were related to cell differentiation. The data from this study supports the conclusion that COS are bioactive compounds that exert a direct effect on both intestinal cells as well as immunomodulatory cells.

### Example 3

The researchers performed an in vivo trial to evaluate whether and to what extent the COS can have an effect in the animal, using laying hen as the model.

Materials and Methods: The effects of dietary supplementation of COS were evaluated in a laying hen trial over a duration of 60 days. A total of 20 HiSex laying hens were used in this experiment, with two diets and 10 replicates per diet. Dosages were determined based on extrapolation of the in vitro cell culture data. Laying hens were allocated into two different groups: (T1) Control and (T2) COS (prepared by partial hydrolysis of shrimp chitin; 50 mg/kg feed). The diets were based on wheat (˜55%), soybean and sunflower meal.

Results: The COS treatment showed throughout the trial to have a beneficial impact on laying hen performance, nutrient digestibility (with particular focus on the fibre fraction) and gut health (shown in Table 1). Furthermore, based on the LDA analysis, cecal microbiome 16S sequencing data reveal that the Veillonellales-Selenomonadales order (enriched with FC=1.7; P=0.01) and the Prevotellaceae family (down-regulated with FC=1.5; P=0.001) are biomarkers for COS-supplemented animals.

TABLE 1
Means for the effect of COS on performance, egg
quality, nutrient digestibility and intestinal morphology
of laying hens. Means within the same row with different
superscripts (a, b) are significantly different at P < 0.05.

| | | | | | | | P |
|---|---|---|---|---|---|---|---|
| | | Control | | COS | | SE | value |
| Performance | Egg | 61.3 | ^{b} | 62.4 | ^{a} | 0.19 | <.0001 |
| → | weight | | | | | | |
| | g | | | | | | |
| | Laying | 92.5 | | 94.5 | | 1.21 | 0.7 |
| | % | | | | | | |
| | FCR | 1.92 | ^{a} | 1.85 | ^{b} | 0.02 | 0.006 |
| Egg quality | Yolk | 6.8 | ^{b} | 9.7 | ^{a} | 0.21 | <.0001 |
| → | Color | | | | | | |
| | Score | | | | | | |
| | Haugh | 83.2 | ^{b} | 88.9 | ^{a} | 0.74 | <.0001 |
| | Unit | | | | | | |
| Nutrient | Dry | 62.1 | ^{b} | 66.4 | ^{a} | 0.76 | 0.0009 |
| Digestibility | Matter | | | | | | |
| → | % | | | | | | |
| | Organic | 68.4 | ^{b} | 72.7 | ^{a} | 0.60 | <.0001 |
| | Matter | | | | | | |
| | % | | | | | | |
| | Crude | 77.8 | ^{b} | 82.8 | ^{a} | 0.42 | <.0001 |
| | Protein | | | | | | |
| | % | | | | | | |
| | AMEn | 2437.1 | ^{b} | 2589.1 | ^{a} | 21.15 | <.0001 |
| | kcal/kg | | | | | | |
| | Gross | 68.8 | ^{b} | 72.9 | ^{a} | 0.57 | <.0001 |
| | Energy | | | | | | |
| | % | | | | | | |
| | Crude | 4.0 | ^{b} | 22.1 | ^{a} | 0.78 | <.0001 |
| | Fibre % | | | | | | |
| Intestinal | Villus | 677.9 | ^{b} | 837.2 | ^{a} | 19.12 | <.0001 |
| morphology | height | | | | | | |
| → | μm | | | | | | |
| | Villus | 193.6 | ^{b} | 211.2 | ^{a} | 6.78 | 0.03 |
| | width | | | | | | |
| | μm | | | | | | |
| | Villus | 0.865 | ^{b} | 1.113 | ^{a} | 0.04 | <.0001 |
| | surface | | | | | | |
| | area | | | | | | |
| | mm² | | | | | | |

Although previous studies have investigated COS, those studies included poorly characterized heterogeneous mixtures, and conventionally COS has been derived from highly deacetylated chitosan instead of chitin. For example, Piao et al. (2008) described a COS from chitosan and its effect on microbiota in poultry (DOI: 10.2527/jas.2007-0668⋅Source: PubMed). In contrast the COS used in this example were well-defined in terms of the molecular weight (1008 g/mol), mean degree of polymerization (4), and high degree of acetylation (>90%). These characteristics were critical, as the results show that these characteristics strongly influence the biological activities of COS, which before this work was not previously known. Further, the researchers determined that the product is water-soluble, which offers interesting application opportunities. The laying hen data in this example indicate that COS might provide health benefits, particularly if combined with other ingredients to provide a stimbiotic approach for animal intestinal health.

### Example 4

The researchers combined xylanase and COS in a two-by-two factorial design study in order to investigate the impact of combining xylanase and COS on animal intestinal health, and specifically the microbiome.

Materials and Methods: The effects of dietary supplementation of a combination of xylanase/COS (prototype or “CXNRGY”) were evaluated in a laying hen trial over a duration of 60 days. A total of 40 HiSex laying hens were used in this experiment, with four diets and 10 replicates per diet. Dosages were determined based on extrapolation of the in vitro cell culture data. Laying hens were allocated into four different groups: (T1) Control; (T2) COS alone (prepared by partial hydrolysis of shrimp chitin; 50 mg/kg feed); (T3) xylanase alone, using Xygest HT (Kemin Industries, Inc.); (T4) and a combination of xylanase and COS. The diets were based on wheat (˜55%), soybean and sunflower meal.

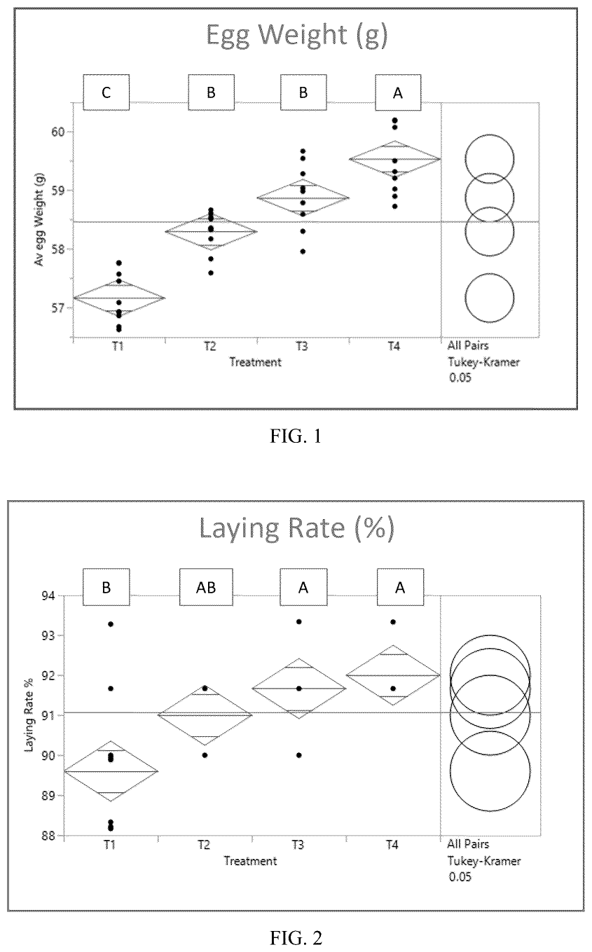

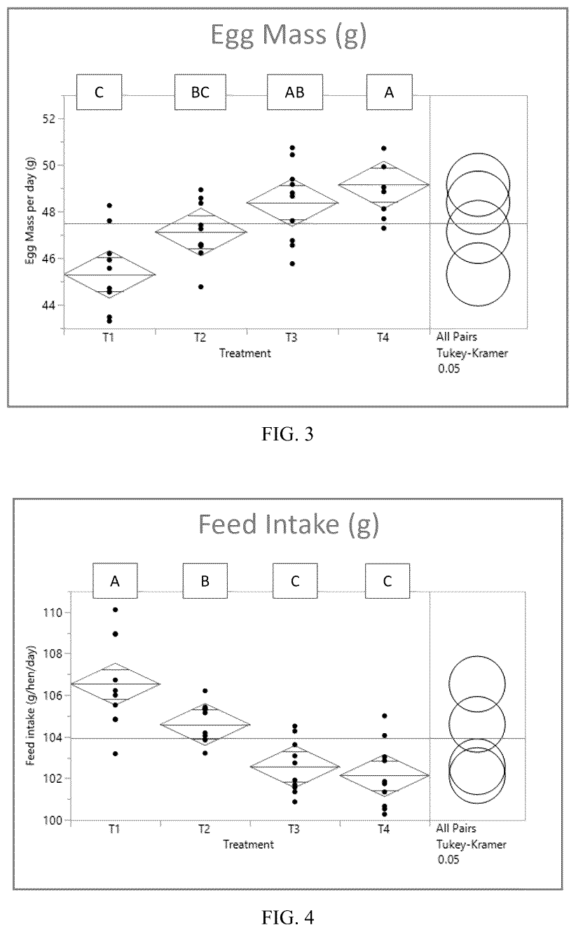

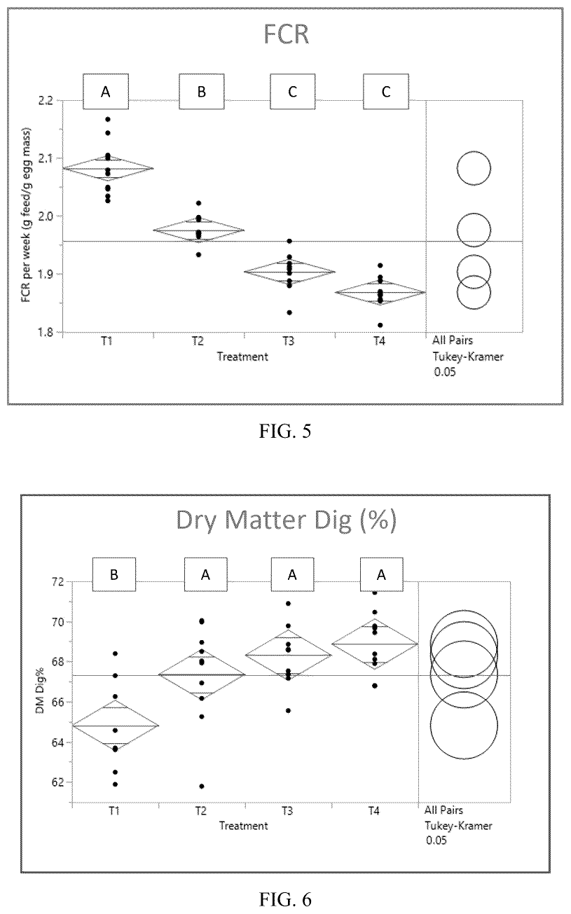

Results: The data established that the combination of the two compounds has a synergistic positive effect on intestinal health and thereby animal performance, as shown in greater detail in FIG. 1-5 and Table 2. More specifically, the weight of the eggs of the hens supplemented with COS significantly increased (P<0.0001) and this is mostly visible in the CXNRGY group which reveals significant higher egg weights compared to the three other groups. Also, the researchers reported a significant increase in laying percentage in the Xygest HT and the CXNRGY group compared to the control group. Finally, and very importantly, there was a drastic reduction in FCR for the CXNRGY treated animals compared to the control counterparts (P<0.0001). Interestingly, there was a tendency for better FCR in the CXNRGY group compared to the Xygest HT and COS treated groups. The latter implies that the CXNRGY treatment impacts more drastically on performance than the two molecules (COS or Xygest HT) individually.

TABLE 2
The synergistic effect of the combination of COS and
xylanase in the protoype (combination of COS and
xylanase) compared to the control treatment.

| | % Improvement | | | |
|---|---|---|---|---|
| | | | Additive | Synergistic |
| | | | effect | effect of |
| | | | of separate | combined |
| | COS | Xylanase | treatments | COS + xylanase |
| Egg weight | 1.13 | 0.58 | 1.708 | 2.365 |
| FCR | −0.11 | −0.07 | −0.178 | −0.214 |
| Egg mass | 1.84 | 0.91 | 2.752 | 3.557 |

The study showed that the individual compounds can beneficially impact the intestinal health, as measured by egg weight and feed conversion ratio (FCR), and thereby animal performance, but further still the data surprisingly showed a synergistic effect when the composition containing both xylanase and COS were added to the animal diet.

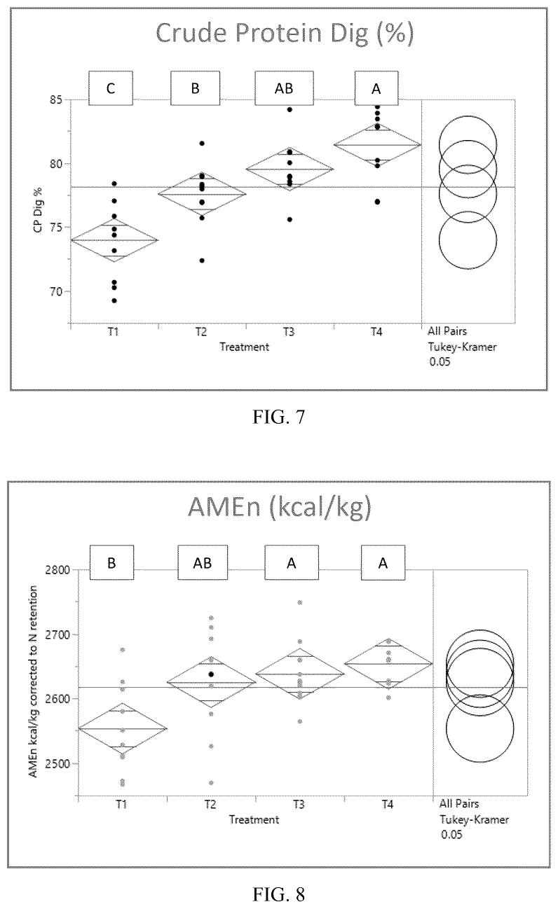

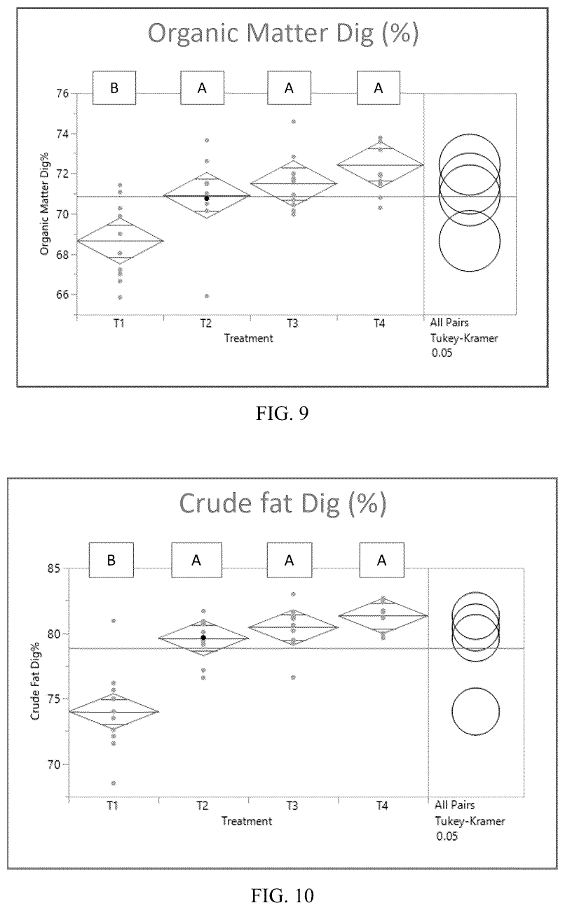

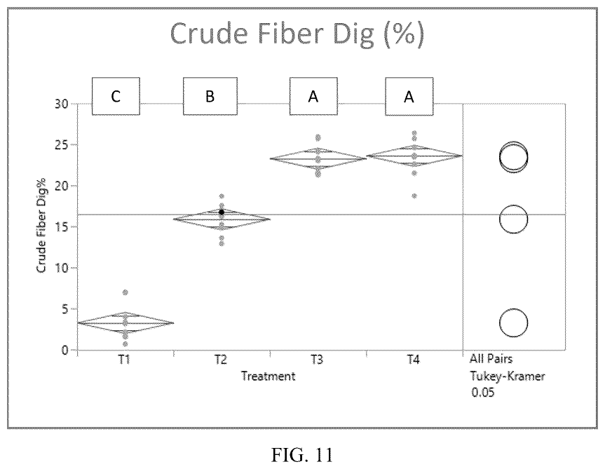

The digestibility data (shown in FIG. 6-11) revealed a significant impact of the prototype when compared to the Control, xylanase alone, or COS alone. More specifically, when checking the effect of COS separately, there is a clear improvement on almost all digestibility parameters studied. Even a better effect is observed for the Xygest HT treatment group. The results showed that the best digestibility of nutrients was obtained in the CXNRGY treatment compared to the three other treatments. The CXNRGY treatment has numerically always a better efficiency in nutrient digestibility compared to the individual compounds.

Additionally, the researchers observed that egg quality was significantly improved for the group of laying hens that received the protype compared to the Control (T1), COS alone (T2), xylanase alone (T3), or the combination of COS and xylanase (T4), as summarized in Table 3.

TABLE 3
Summary of egg characteristics.

| | | | | | | |
|---|---|---|---|---|---|---|
| | | | T3: | | | |
| | | | xylanase | T4: | | |
| | | | alone | Prototype | | |
| | T1: | T2: COS | (Xygest | (COS- | | |
| Parameters | Control | alone | HT) | xylanase) | SEM | P-value |

Yolk Color Score (DSM method)

| | | | | | | |
|---|---|---|---|---|---|---|
| End of Phase 1 | 4.8 b | 4.8 b | 5.3 a | 5.4 a | 0.163 | 0.0059 |
| End of Phase 2 | 4.7 b | 5.3 b | 6.7 a | 7.3 a | 0.325 | <.0001 |

Albumin Height, mm

| | | | | | | |
|---|---|---|---|---|---|---|
| End of Phase 1 | 6.4 b | 7.0 a | 7.1 a | 7.4 a | 0.220 | 0.0156 |
| End of Phase 2 | 6.5 c | 7.2 b | 7.9 a | 8.1 a | 0.239 | <.0001 |

Haugh Unit (HU)

| | | | | | | |
|---|---|---|---|---|---|---|
| End of Phase 1 | 80.5 b | 83.8 ab | 84.3 a | 85.7 a | 1.284 | 0.0358 |
| End of Phase 2 | 79.5 b | 84.4 a | 88.7 a | 89.0 a | 1.720 | 0.0004 |

Shell Breaking Strength, kg · force

| | | | | | | |
|---|---|---|---|---|---|---|
| End of Phase 1 | 4.0 b | 4.3 ab | 4.6 a | 4.6 a | 0.166 | 0.0394 |
| End of Phase 2 | 3.8 bc | 4.3 b | 4.7 ab | 5.1 a | 0.182 | <.0001 |

Egg Shell Thickness, mm

| | | | | | | |
|---|---|---|---|---|---|---|
| End of Phase 1 | 0.363 b | 0.384 a | 0.397 a | 0.391 a | 0.005 | <.0001 |
| End of Phase 2 | 0.364 b | 0.383 b | 0.428 a | 0.423 a | 0.008 | <.0001 |

Yolk Height, mm

| | | | | | | |
|---|---|---|---|---|---|---|
| End of Phase 1 | 18.0 | 18.7 | 18.7 | 18.6 | 0.384 | 0.5050 |
| End of Phase 2 | 17.7 b | 18.2 ab | 18.3 ab | 18.7 a | 0.243 | 0.0469 |

Yolk Diameter, mm

| | | | | | | |
|---|---|---|---|---|---|---|
| End of Phase 1 | 42.2 | 43.5 | 43.2 | 44.0 | 0.692 | 0.3200 |
| End of Phase 2 | 48.1 | 44.7 | 44.2 | 44.8 | 1.858 | 0.4257 |

Yolk Index

| | | | | | | |
|---|---|---|---|---|---|---|
| End of Phase 1 | 0.43 | 0.43 | 0.44 | 0.42 | 0.013 | 0.9391 |
| End of Phase 2 | 0.39 b | 0.41 ab | 0.42 a | 0.42 a | 0.010 | 0.0696 |

To summarize, the group that received the prototype, containing both xylanase and COS resulted in a positive effect on laying hen performance, egg quality and nutrient digestibility.

### Example 5

The researchers performed a study in growing poultry, in which xylanase and COS were combined in a dose response study in order to study the impact of combining xylanase and COS on poultry growth.

Materials and Methods: The effects of dietary supplementation of a combination of xylanase/COS were evaluated in a broiler trial over a duration of 35 days. A total of 1200 Ross broilers were used in this experiment, with five diets and 12 replicates per diet. Broilers were allocated into five different groups as presented in Table 4.

TABLE 4
Summary of treatments.

| Treatment | | | Xygest HT, | COS, |
|---|---|---|---|---|
| code | | Description | g/t feed | g/t feed |
| T1 | Gr | Control (basal diet) | — | — |
| T2 | Rs | Xylanase | 10 | — |
| T3 | Li | Novel compound, dose | 5 | 25 |
| | | A | | |
| T4 | Ao | Novel compound, dose | 10 | 25 |
| | | B | | |
| T5 | Rj | Novel compound, dose | 10 | 50 |
| | | C | | |

Results: Zootechnical performance results are summarized in [symbol] . 5, showing the heaviest body weight (BW) were observed in treatment groups T2 and T4, while T3 broilers were the lightest. During the starter phase (0-14 days), no significant differences in performance were observed between treatments. During the grower phase (15-35 days), broilers on T4 and T5 treatments grew more and exhibited lower feed conversion than broilers on T3 and T1. Focusing on the global trial performance, broilers on T2, T4 and T5 treatments grew significantly more and exhibited higher EPEF than broilers on T3. In addition, broilers on T4 and T5 exhibited significantly lower feed conversion than broilers on T1 and T3.

TABLE 5
Zootechnical performance for each study phase and global phase.

| Treatment | T1 | T2 | T3 | T4 | T5 | SEM | P-value |
|---|---|---|---|---|---|---|---|
| Xygest HT, g/t feed | — | 10 | 5 | 10 | 10 | | |
| COS, g/t feed | — | — | 25 | 25 | 50 | | |
| Body weight, g | | | | | | | |
| Trial start | 43.0 | 43.0 | 43.0 | 43.0 | 43.0 | — | — |
| 14 days of age | 376 | 386 | 379 | 384 | 378 | 3.9 | 0.3626 |
| Trial end, 35 days of age | 2025^{ab} | 2069^{a} | 2001^{b} | 2062^{a} | 2045^{ab} | 18.9 | 0.0824 |
| Starter phase, 0-14 days | | | | | | | |
| of age | | | | | | | |
| ADG, g/d | 23.7 | 24.5 | 23.9 | 24.2 | 23.9 | 0.29 | 0.3351 |
| ADFI, g/d | 32.2 | 32.9 | 33.2 | 32.4 | 32.7 | 0.34 | 0.2432 |
| FCR | 1.36 | 1.35 | 1.39 | 1.34 | 1.37 | 0.015 | 0.1165 |
| M-ADG, g/d | 23.7 | 24.4 | 23.9 | 24.1 | 23.8 | 0.29 | 0.4075 |
| M-ADFI, g/d | 32.0 | 32.8 | 33.0 | 32.0 | 32.5 | 0.32 | 0.1438 |
| M-FCR | 1.35^{ab} | 1.34^{ab} | 1.38^{b} | 1.33^{a} | 1.36^{ab} | 0.014 | 0.0747 |
| Mortality, % | 3.3 | 1.7 | 2.5 | 2.9 | 2.5 | 1.00 | 0.8201 |
| Grower phase, 15-35 | | | | | | | |
| days of age | | | | | | | |
| ADG, g/d | 78.5^{ab} | 80.0^{a} | 76.8^{b} | 79.9^{a} | 79.3^{a} | 0.78 | 0.0393 |
| ADFI, g/d | 123.6 | 123.7 | 121.9 | 122.1 | 121.8 | 1.28 | 0.7054 |
| FCR | 1.57^{bc} | 1.55^{ab} | 1.59^{c} | 1.53^{a} | 1.54^{ab} | 0.013 | 0.0107 |
| M-ADG, g/d | 78.5^{ab} | 79.9^{a} | 76.7^{b} | 79.8^{a} | 79.3^{a} | 0.79 | 0.0407 |
| M-ADFI, g/d | 123.6 | 123.3 | 120.5 | 121.6 | 121.3 | 1.16 | 0.2675 |
| M-FCR | 1.57^{b} | 1.54^{ab} | 1.57^{b} | 1.52^{a} | 1.53^{a} | 0.011 | 0.0065 |
| Mortality, % | 0.0^{a} | 0.9^{ab} | 2.1^{b} | 0.4^{a} | 0.4^{a} | 0.51 | 0.0507 |
| Global trial, 0-35 | | | | | | | |
| days of age | | | | | | | |
| ADG, g/d | 56.6^{ab} | 57.7^{a} | 55.4^{b} | 57.6^{a} | 57.1^{a} | 0.54 | 0.0330 |
| ADFI, g/d | 87.1 | 87.2 | 86.0 | 86.1 | 86.1 | 0.78 | 0.6883 |
| FCR | 1.54^{bc} | 1.51^{ab} | 1.55^{c} | 1.50^{a} | 1.51^{ab} | 0.012 | 0.0070 |
| M-ADG, g/d | 56.5^{ab} | 57.5^{a} | 55.4^{b} | 57.4^{a} | 57.0^{a} | 0.54 | 0.0449 |
| M-ADFI, g/d | 86.8 | 86.8 | 85.1 | 85.5 | 85.7 | 0.73 | 0.3259 |
| M-FCR | 1.54^{b} | 1.51^{ab} | 1.54^{b} | 1.49^{a} | 1.50^{a} | 0.010 | 0.0048 |
| Mortality, % | 3.3 | 2.5 | 4.6 | 3.3 | 2.9 | 1.11 | 0.7415 |
| EPEF | 356^{ab} | 372^{a} | 341^{b} | 372^{a} | 368^{a} | 7.3 | 0.0160 |

[symbol]

replicates = 12 replicates/treatment all treatments (each pen replicate of 20 birds).
Values shown are least squares means. Means separated by Duncan. Values in same row with no common superscript are significantly different (a-c: P ≤ 0.05).
SEM = Standard error of mean;
M-ADG = mortality adjusted mean daily gain,
M-ADFI = mortality adjusted mean daily feed intake;
M-FCR = Mortality adjusted feed:gain;
EPEF = European Production Efficiency Factor.

In accordance with trial conditions, the researchers were able to conclude that the combination of COS at a dosage of 25 g/t in combination with xylanase (Xygest HT) at 10 g/t showed improved global zootechnical performance of broilers, specifically improvements in broiler growth and a lower FCR.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

1. A method of improving animal performance comprising the step of adding to the animal diet or water a composition comprising beta 1-4, endo-xylanase enzyme and chito-oligosaccarides (COS) in an amount sufficient to improve animal performance.

2. The method of claim 1, wherein the composition is water soluble.

3. The method of claim 1, wherein the animal is a monogastric animal.

4. The method of claim 1, wherein the animal performance is measured by increased weight gain or reduced feed conversion ratio.

5. The method of claim 1, wherein the animal performance is measured by increased milk yield, improved egg quality score, increased weight gain per egg, increased egg production, or improved egg characteristics including egg weight, yolk color, haugh unit, and/or proportion of dirty or cracked eggs.

6. The method of claim 1, wherein the animal performance is measured by decreased serum concentrations of TNF-α, IL-1α, and IL-10.

7. The method of claim 1, wherein the COS is an oligomer of N-acetylglucosamine with an average degree of polymerization between 2 and 6 monomers and a degree of acetylation greater than 90%.

8. The method of claim 1, wherein the COS has an average molecular weight less than 4 kDa.

9. The method of claim 8, wherein the COS has an average molecular weight less than 2 kDa.

10. The method of claim 1, wherein the animal diet contains the composition in an amount ranging from about 10 g/ton feed to about 100 g/ton feed.

11. A feed additive or supplement comprising beta 1-4, endo-xylanase enzyme and chito-oligosaccarides (COS) in an amount sufficient to improve monogastric animal intestinal health and/or nutrient digestion and absorption.

12. The feed additive or supplement of claim 11, wherein the composition is water soluble.

13. The feed additive or supplement of claim 11, wherein the animal intestinal health is measured by showing a positive effect on the animal microbiome.

14. The feed additive or supplement of claim 11, wherein the nutrient digestion and absorption is measured by increased weight gain or reduced feed conversion ratio.

15. The feed additive or supplement of claim 11, wherein the nutrient digestion and absorption is measured by an increased milk yield, improved egg quality score, increased egg production, or improved egg characteristics including egg weight, yolk color, haugh unit, and/or proportion of dirty or cracked eggs.

16. The feed additive or supplement of claim 11, wherein the COS is an oligomer of N-acetylglucosamine with an average degree of polymerization between 2 and 6 monomers and a degree of acetylation greater than 90%.

17. The feed additive or supplement of claim 11, wherein the COS has an average molecular weight less than 4 kDa.

18. A method of improving monogastric animal performance comprising the step of adding a composition to the animal diet or water that contains an effective amount of xylanase and chito-oligosaccarides (COS) compared to the administration of the xylananse alone or the COS alone.

19. The method of claim 18, wherein the animal performance is measured by an increased milk yield, improved egg quality score, increased egg production, or improved egg characteristics including egg weight, yolk color, haugh unit, and/or proportion of dirty or cracked eggs.

20. The method of claim 18, wherein the COS is an oligomer of N-acetylglucosamine with an average degree of polymerization between 2 and 6 monomers and a degree of acetylation greater than 90%.
